(19) United States
(12) Patent Application Publication
(10) Pub. No.: US 2024/0307952 A1
(43) Pub. Date: Sep. 19, 2024

(54) METHOD AND CAST PART PRODUCTION SYSTEM FOR PRODUCING AN ELECTRIC MOTOR HOUSING, AND ELECTRIC MOTOR

(71) Applicant: AE GROUP AG, Gerstungen (DE)

(72) Inventors: Peter LUTZE, Soltau (DE); Daniel KREZ, BAD HERSFELD (DE); Kenneth PETERS, SUESS (DE)

(21) Appl. No.: 18/546,833

(22) PCT Filed: Feb. 11, 2022
(86) PCT No.: PCT/EP2022/053397

§ 371 Date: Aug. 17, 2023

(30) Foreign Application Priority Data
Feb. 19, 2021 (DE) 10 2021 104 024.8
Nov. 3, 2021 (EP) 21206171.7

(51) Int. Cl. B22D 19/00; B22C 9/10; H02K 15/02; H02K 15/14

(52) U.S. Cl. CPC B22D 19/0054; B22C 9/105; H02K 15/02; H02K 15/14; H02K 2215/00

(57) ABSTRACT

The invention relates to a method for producing an electric motor housing, comprising the steps: (a) positioning at least stator part (30) in a support body interior chamber of support body (22), (b) arranging a casting core (42) on the support body (22), (c) then casting the liquid metal around the support body (22) and the casting core (42), resulting in a torque-proof connection between stator part (30) and a casting (26) as a result of the solidification of the liquid metal.

The invention relates to a method for producing a cast part in the form of an electric motor housing. According to a second aspect, the invention relates to a cast part production system for producing an electric motor housing and an electric motor, which comprises a one-piece and/or monobloc cast housing or housing component in which a cooling channel extends which, at least in sections, does not extend in a straight line.

Such electric motors are used in electric vehicles, for example. In order to discharge inevitable waste heat, at least one cooling channel is provided in the housing of the electric motor, through which a cooling fluid, often water or an aqueous solution, but perhaps oil, is conducted.

It is known to produce this housing as a two-part piece comprising an inner part and an outer part that surrounds the inner part. In this case, a groove is applied to the outside of the inner part, which interacts with the inside of the outer part and forms the cooling channel. The disadvantage of this is that it places high demands on the dimensional stability of the two housing halves. Dimensional stability, quality and the type of connection of the two components are decisive for the tightness of the assembly. Leakages of the coolant may otherwise occur, which may jeopardise the operational safety of the motor.

It is also known to cast around a pipeline produced, for example, by high-pressure internal forming between two aluminium sheets. In order for this pipeline to withstand the mechanical stress of being cast around, which is usually achieved via injection moulding, the pipeline often contains a support material, usually salt, which is washed out afterwards. However, it transpires that the transfer of heat into the cooling fluid is in many cases not as high as expected.

EP 3 208 013 A1 describes a method for casting a component with a complex geometry. In this method, a casting mould is used, at least one mould part of which is constructed as a lost mould made from salt. An outer part of the cast mould, which determines the external geometry of the component, or an inner part of the cast mould, which determines the internal geometry of the component, is composed of at least two segments. It is thus also possible to produce complex components, such as a coil, with a smooth surface through casting.

EP 1 293 276 A2 describes a device for producing a die-cast component comprising an insert using a salt core. The insert supports the core during casting. There is a connection between the insert and the core, which is tight with respect to the cast metal.

EP 2 647 451 A1 describes a method for producing a salt core by means of hot chamber die casting. This die casting method prevents adhesion of the molten salt to the metering device components.

DE 10 2014 007 889 A1 discloses a method for producing a salt body suitable for use in die casting. In this method, a model for the salt body is first produced from a polymer foam. This model is moulded into a mould box with the aid of a moulding material and poured off with the molten salt. In the process, the polymer foam decomposes.

DE 10 2012 002 331 A1 describes a method for producing a salt core to be used in aluminium die casting. To this end, the corresponding salt mixture is heated, thereby forming a semi-solid salt paste that is injected into a core mould by means of an extruder. The salt core is subsequently de-moulded.

To produce the electric motor, it also necessary to securely connect a stator part to the housing. Given that the degree of effectiveness of the electric motor depends on the air gap between rotor and stator, tight tolerances must be observed when mounting the stator part, which is costly. In addition, it must be ensured that the stator part is connected to the housing in a torque-proof manner. This requires a complex production.

The invention aims to reduce disadvantages of the prior art.

The invention solves the problem by way of a method with the features of claim 1.

According to a second aspect, the invention solves the problem by way of an electric motor according to the preamble of claim 1 in which the housing or the housing component that abuts the cooling channel is produced entirely from identical casting material. In other words, the cooling channel is not completely bounded in the radial direction by a material or body that was not created or solidified during casting of the salt moulded part. In particular, the cooling channel is not bounded by an insert. Rather, the cooling channel is bounded in at least the radial direction by the same material from which the rest of the housing or housing component is made. In particular, the housing is free from joints in the area of the cooling channel. According to a preferred embodiment, the housing or housing component is made entirely of identical casting material.

The advantage of the invention is that the stator part can be easily connected to the housing. This allows the stator carrier to be connected to the electric motor housing and the cooling channel to be created in just one injection moulding process.

A further advantage of the invention is that the heat introduced at a part of the housing, for example from a stator, is conducted to the cooling channel by thermal conduction of the casting material, i.e. the material from which the cast part was cast. In particular, this does not require a transition point to be overcome between the cast material and a cast-in insert surrounding the channel.

The advantage of the invention is that the housing or housing component need not be produced by joining two partial housings or partial housing components, but can generally be produced in a single casting process. The production process is therefore usually less complex.

Within the context of the present description, the molten metal preferably contains aluminium, zinc, magnesium or an alloy of at least one of these metals. To simplify matters, in the following we will also refer to liquid metal instead of molten metal. The molten metal may contain non-metallic components, for example fibres or particles.

A stator part refers to a component that acts as a stator during operation of the electric motor produced from the electric motor housing. In particular, the stator part preferably includes at least one coil for generating a magnetic field.

The casting core is understood to be a component that is not the support body and is inserted into the injection mould in a solid form and does not completely dissolve during injection moulding. According to a preferred embodiment, the casting core is a salt moulded part. According to an alternative embodiment, the casting core is a pipe filled with salt.

A salt moulded part refers in particular a three-dimensional object that contains or is made of salt, especially a salt mixture, and can be destabilised by water to such an extent that is can be removed from the blank. The salt moulded part can also be referred to as a salt core. The salt moulded part is preferably composed of at least 20 percent by weight, in particular at least 30 percent by weight, more preferably at least 50 percent by weight, of salt or a salt mixture. The salt moulded part may contain a granular material, for example a granulate made of inorganic material, particularly sand; however, this is not necessary.

The salt moulded part is generally brittle. Therefore, it was expected that this salt component would not have sufficient strength to be cast and handled by die casting. Surprisingly, however, it has been proven that this is indeed possible, in particular when a support body is used.

The positioning of the stator part in the support body interior chamber of the support body is understood particularly to mean that the stator part is surrounded by the support body in the radial direction across at least half, especially at least two thirds, preferably at least 0.9-times, its longitudinal extension.

In particular, the stator part is positioned so that it is in contact with the support body. Preferably, the stator part and the support body form a clearance fit or a transition fit in accordance with ISO 284 4.2010. A gap between the stator part and the support body is preferably at least 1/10 mm. This is understood to mean that the stator part can be moved relative to the support body by at least a tenth of a millimetre in at least one radial direction.

Positioning is, for example, mounting or inserting, in particular pushing in.

An electric motor is understood to be a device by means of which electrical energy can be converted into kinetic energy, in particular rotational kinetic energy. Since an electric motor can in principle also be operated as a generator, an electric motor within the meaning of this description is also understood to be a generator.

Preferably, the process comprises the steps of de-moulding the electric motor housing, which is produced by casting the liquid material around the support body.

Preferably, the method comprises the step of incorporating a rotor into a stator interior chamber of the stator part so as to form an electric motor.

According to a preferred embodiment, the support body is arranged in a mould in such a way that the interior chamber of the support body is sealed against the casting mould. The casting mould is preferably an injection mould. The injection mould is composed of at least two mould parts. If the injection mould comprises exactly two mould parts, as provided for according to a preferred embodiment, these mould parts are also referred to as mould halves.

Preferably, casting around the support body is done in such a way that no liquid metal enters the interior. This ensures that the stator part does not come into contact with liquid metal.

The process of casting around something can also be understood to mean casting onto something; however, this is not necessary. Casting around something can also not be casting onto something.

Preferably, the casting core is cast around in such a way that it is completely enclosed by the casting except for the openings at the edges.

According to a preferred embodiment, casting is done at an injection pressure that is selected to be so great that the support body deforms radially inwards. In particular, the support body deforms in such a way that a torque-proof connection forms between the stator part and the support body.

Alternatively or additionally, the injection pressure and/or a densification pressure is preferably selected in such a way that the torque-proof connection forms between the stator part and the casting.

According to a preferred embodiment, the method comprises the step of closing the casting mould by moving at least two mould parts towards each other after the support body has been arranged in the casting mould. Preferably, when the at least two mould parts are moved towards the support body, the support body is sealed against the casting mould, in particular at its support body end faces. This is a simple way to ensure that no liquid metal enters the interior chamber of the support body.

The stator part is preferably fixed in the casting mould. This is understood to mean that a movement of the stator part relative to the casting mould is prevented. This ensures that all stator parts produced with the casting mould are always in the same position relative to the casting mould and thus relative to the respective housing produced, relative to the contour of the housing. It is therefore possible to position the rotor with a very small positional tolerance. This in turn allows the rotor to be produced in such a way that a small air gap is created, which increases the effectiveness of the electric motor.

During injection moulding, the stator part does not move relative to the casting mould due to the fixing. If the support body deforms, the support body moves locally relative to the stator part and thus to the contour of the subsequent housing, whereas the stator part does not.

Preferably, the stator part has such a radial strength that the stator interior chamber has the same interior dimensions after de-moulding the casting as after positioning in the support body and before casting around it. The feature that the stator interior chamber has the same interior dimensions is understood particularly to mean that an inner diameter of the stator interior chamber is reduced by at most 3/10 mm, in particular at most 2/10 mm. The inner diameter is the diameter of the imaginary cylinder of maximum diameter that does not touch the stator interior chamber at any point.

Preferably, the stator part is positioned in the support body interior chamber such that the stator part does not form a press fit with the support body before casting. In particular, the stator part forms a clearance fit or a transition fit.

The casting core is preferably a salt moulded part or a pipe with a salt core. The pipe is preferably made of metal, especially an aluminium alloy, particularly a wrought aluminium alloy.

The method preferably comprises the step of dissolving the salt moulded part or the salt core, in particular by means of water or another solvent. It is beneficial if dissolving the salt moulded part or the salt core results in a channel. The channel is preferably a cooling channel. A cooling channel is understood to be a channel that can be flushed with a cooling fluid. To this end, the electric motor housing preferably has at least two cooling fluid connections, so that cooling fluid can flow into the cooling channel through one of the cooling fluid connections and out of it through at least one of the cooling fluid connections.

According to a preferred embodiment, the stator part has a stator part projection and/or a stator part recess on its stator part outer side and the support body has a support body recess on its support body inner side, said recess forming a form-fit connection with the stator part projection, and/or a support body projection, which forms a form-fit connection with the stator part recess. Of course, one projection/recess pair is sufficient.

Alternatively or additionally, the stator part preferably has a stator part projection and/or a stator part recess on at least one of its stator part end faces that forms a form-fitting connection with a support body recess or a support body projection, respectively.

Casting is preferably done in such a way that the salt moulded part comes into direct contact with the molten metal. The molten metal is the mould material.

Preferably, casting refers to a die-casting. In particular, casting is performed at a maximum pressure of at least 15 Mpa (150 bar). This maximum pressure is preferably not applied constantly during casting, but in particular after mould filling has been completed.

It is possible, but not necessary, for the metal to be liquid in the strict sense. The only decisive factor is the metal is capable of flowing. Paste-like or dough-like metal is therefore also considered to be liquid metal.

It is beneficial if the casting core, in particular the salt moulded part, is curved at least in sections, in particular curved in the shape of a circular section. In particular, the salt moulded part can be designed to be helical, at least in sections.

It has been proven that the process safety during production of the cast part can be increased if the casting core, in particular the salt moulded part—as provided for in a preferred embodiment—is supported by means of a support body when being inserted into the casting mould in which the salt moulded part is cast around.

It is especially beneficial if the casting core, especially the salt moulded part, is supported when being cast around by means of a support body, which represents a preferred step in the method according to the invention.

The material of the support body is preferably a metal, in particular aluminium, copper, zinc, steel or an alloy of one of these metals. It is beneficial if the support body is an extruded component.

Preferably, the support body is made of a material whose melting point is above the temperature at which the metal is cast onto the support body, preferably by at least 5 Kelvin, especially by at least 10 Kelvin, especially preferably by at least 15 Kelvin. Preferably, the support body is made of a material whose melting point is above the melting temperature of the metal that is cast around the support body, preferably by at least 5 Kelvin, especially by at least 10 Kelvin, especially preferably by at least 15 Kelvin.

Preferably, the support body is made of a material whose melting point is above the melting temperature of the molten mass of the salt or the salt mixture, preferably by at least 5 Kelvin, especially by at least 10 Kelvin, especially preferably by at least 15 Kelvin.

Preferably, the insertion is a pouring of liquid salt or a liquid salt mixture into a salt moulded part casting mould.

Alternatively, the insertion of salt or the salt mixture into the salt moulded part casting mould is done using core shooting. In the core shooting process, a mixture of salt powder or a salt powder mixture, which preferably contains soluble glass, is injected under pressure into the salt moulded part mould, thus forming the support body.

The support of the casting core, in particular the salt moulded part, during casting is preferably done in such a way that the salt moulded part rests against the support body and/or on the support body, at least in sections. If the casting core, in particular the salt moulded part, is designed to be helical, at least in sections, the support body preferably has, at least in sections, a cylindrical outer surface, against which the support body rests. As a result, the support body can absorb forces acting radially inwards on the salt moulded part. The term radially inwards refers to the longitudinal axis of the cylinder axis of the cylindrical section.

Casting is preferably done in such a way that the solidifying molten metal forms a material/frictional or form-fitting connection with the support body. In other words, casting around the salt moulded part also constitutes casting onto the support body, in particular casting onto an outer side of the support body.

It is beneficial if the support body is made of a material consisting of at least 50% iron. In this case in particular, it is beneficial if the support body comprises a coating, preferably a nickel coating, on its outer side. This coating facilitates the formation of a material connection between the support body and the surrounding casting.

It is beneficial if the method comprises the step of profiling and/or roughening an outer surface of the support body. Roughening is understood to mean any processing that increases the average roughness value in accordance with DIN EN ISO 4287:2010 by at least 1 μm, preferably at least 2 μm, and/or at least doubles, but preferably at least triples, the average roughness value.

It is beneficial if the method comprises the step of contouring and/or roughening an inner surface of the support body.

The profiling and/or roughening is preferably done via laser surface processing and/or by means of machining, particularly by machining with geometrically defined cutting edge.

Casting is preferably done in a casting mould, particularly an injection mould. It is beneficial if the mould is evacuated before casting. However, this is not essential. It is also possible that casting is done, for example, on a non-evacuated casting mould. Alternatively, casting can be done by gravity casting.

The casting mould may be a lost mould, but generally it is cheaper if the casting mould is reusable, especially a metal casting mould.

Along a longitudinal axis of an inner bevelled cylinder, the support body preferably has a cylindrical or truncated cone-shaped lateral surface, at least in sections, but in particular across more than 50% of its length. It is beneficial if the support body is tubular, at least in sections. The salt moulded part then encloses the support body in a spiral shape, at least in sections.

Dissolving the salt moulded part out of the blank preferably results in a cooling channel. A cooling channel refers in particular to a channel that is suitable for cooling the cast part, especially the housing, in particular by means of water. To this end, the cooling channel is in particular continuous, i.e. a cooling fluid can continuously flow through it from an inlet to an outlet. The cooling channel is preferably designed in such a way that a projection of the cooling channel onto the inner surface of the support body represents at least one tenth, especially at least one eighth, preferably at least one sixth, especially preferably at least one quarter of the inner surface. Alternatively or additionally, the salt moulded part is preferably designed in such a way that a projection of the salt moulded part onto the inner surface of the support body represents at least one tenth, especially at least one eighth, preferably at least one sixth, especially preferably at least one quarter of the inner surface.

The salt part of the salt moulded part is preferably comprised of a salt mixture that contains at least two different salts. It is beneficial if at least one of the salts is a chloride, in particular an alkaline metal chloride. The other salt is preferably a carbonate, such as an alkaline earth carbonate, or a sulphate. It is especially favourable if the salt part of the salt moulded part is comprised of at least 60%, in particular at least 80%, alkaline metal chloride, particularly potassium chloride, and sodium carbonate. It is especially favourable if the salt part of the salt moulded part is comprised of at least 60%, in particular at least 80%, sodium chloride.

It is beneficial if the salt mixture is selected in such a way that a bending strength of a sample, which has been cast from the salt mixture and has the dimensions 45 cm×4 cm×3 cm, is at least 10 Mpa in a three-point flexural test according to DIN EN 843-1.

According to a preferred embodiment, the method includes the steps (i) introducing salt or a salt mixture into a salt moulded part mould that surrounds a support body, the salt, in particular the liquid salt, or the salt mixture, in particular the liquid salt mixture, coming into contact with the support body such that the salt moulded part rests against the support body and (ii) collective de-moulding of the support body and the salt moulded part that rests on, in particular is connected to, the support body.

Preferably, the method includes the step of arranging the salt moulded part and the support body in the casting mould, wherein the salt moulded part is not separated from the support body until arrangement in the casting mould. This effectively protects the salt moulded part from becoming damaged, in particular from breaking.

According to a preferred embodiment, the introduction of salt or a salt mixture into the salt moulded part mould is a core shooting of salt or the salt mixture into a core-shooting mould. Here, it is beneficial if the salt or the salt mixture contains soluble glass.

An independent subject of the present invention is a method for producing a cast part, especially a housing, for example an electric motor housing, comprising the steps (a) producing a salt moulded part, which comprises the following steps: (i) introducing salt or a salt mixture into a salt moulded part mould that surrounds a support body, the liquid salt or the liquid salt mixture coming into contact with a support body, and (ii) de-moulding the salt moulded part, (b) casting around the salt moulded part with metal, especially aluminium, thus producing a blank, (i) the salt moulded part being supporting during casting by means of a support body and (ii) the support body being securely connected to a casting made of the solidified metal due to the casting with metal, and (c) dissolving the salt moulded part out of the blank, resulting in a cast part. The preferred embodiments specified in this description all apply for aspects of the invention.

Preferably, the method comprises the step of producing the salt moulded part by casting, in particular gravity casting, low-pressure die casting or another special die casting process. For example, the method comprises the steps (a) producing a salt moulded part mould, especially a permanent mould, (b) pouring liquid salt or a liquid salt mixture into the salt moulded part mould and (c) de-moulding the salt moulded part.

Alternatively, it is also possible for the salt moulded part to be produced by a different type of casting, such as low-pressure gravity die casting, die casting according to the hot chamber method or by means of a lost mould.

The salt moulded part mould contains a negative structure of the salt moulded part and encloses the support body. The negative structure then abuts the support body, so that the liquid salt or the liquid salt mixture comes into contact with the support body. As a result, in the subsequent cast part, the channel directly abuts the support body. This causes a small heat transfer resistance into the channel or into the fluid in the channel.

The method preferably comprises the step of positioning a stator part relative to the support body. In particular, this constitutes mounting the stator part on the support body. It is beneficial if the liquid metal is then cast around the support body, thereby forming a torque-proof connection between the stator part and a casting as a result of the solidification of the liquid metal. The casting is the metal structure created when the liquid metal solidifies.

The stator part is understood to mean either an integral part of a stator of an electric motor or the stator itself.

According to a preferred embodiment, a casting mould with a collapsible core is used. The collapsible core is preferably used when there is no stator mounted in the support pipe or in order to support areas in which no part of the stator rests against the inside of the pipe. It is beneficial if the collapsible core supports the support body from the inside. The support body is thus protected from becoming deformed by the injection pressure. A collapsible core, which can also be referred to as a folding core, is understood to mean a core that can be brought into a first, expanded state, in which the folding core rests against the support body from the inside, and into a collapsed state, in which the folding core does not rest against the support body from the inside and can be removed from the support body.

The method preferably comprises the steps of inserting a rotor into the housing, particularly in such a way that the support body encloses the rotor in the radial direction (partially or completely). In other words, the rotor is preferably positioned in such a way that it is enclosed by the support body in the radial direction, at least in sections.

The method preferably also comprises the step of connecting the channel to a first connection and a second connection. The first connection and the second connection are configured on the cast part, preferably externally on the cast part. The connection is preferably done in such a way that a fluid, especially a liquid, such as water, can be conducted through the first connection into the channel and back out of the channel by means of the second connection. The channel can thus be used as a cooling channel. In particular, a liquid-cooled electric motor or generator is thus obtained.

In addition, it is beneficial if the at least one electrical conductor of the stator is contacted with a connection on the outside of the cast part. The method also preferably includes the step of finishing the electric motor.

The electric motor may refer to a synchronous motor, an asynchronous motor or a reluctance motor, or a combination of synchronous and reluctance motor.

It is beneficial if the cooling channel of the electric motor or generator according to the invention is not limited by a cast-in pipe. After dissolving the salt moulded part, the cooling channel is then completely fluid-filled, particularly gas-filled.

It is beneficial if the channel has a non-round cross-section. A non-round cross-section is understood especially to mean that a maximum deviation of the cross-section from the inner circle, i.e. the circle of the maximum diameter arranged within the cross-section, is at least 5%, especially at least 10%, of the inner circle diameter. It is beneficial if the channel has a non-circular cross-section across at least 50% of its longitudinal extension. In particular, the cross-section is preferably angular, for example rectangular.

Alternatively or additionally, it is beneficial if the channel has a flat cross-section. A flat cross-section is understood to mean that a maximum expansion of the cross-section that extends in a first spatial direction defined as such corresponds to at least 1.5-times, especially at least two-times, the expansion perpendicular to said direction.

Alternatively or additionally, it is beneficial if the cross-section has an edge length that is at least 10%, especially at least 20%, greater than the edge length of a cross-section of a circle of equal area. The heat transfer from the cast part into the fluid in the channel is thus improved. It is possible, but not essential, for the cross-section to have at least one concave section. This likewise leads to an increase in surface area.

The invention also includes a cast part production system for producing a housing with (a) a salt moulded part production machine for producing a salt moulded part which comprises (i) a salt moulded part mould and (ii) an insertion device that is configured to enclose a support body and to insert salt or a salt mixture into the salt moulded part mould, so that the liquid salt or the liquid salt mixture comes into contact with a support body and (iii) a de-moulding device for de-moulding the salt moulded part, thus creating a pre-blank, (b) an injection moulding machine for injection moulding metal around the salt moulded part, resulting in a blank, and (c) a salt moulded part removal device for releasing the salt moulded part, resulting in the housing.

Preferably, the cast part production system has a first handling device for moving the pre-blank to the injection moulding machine and/or a handling device for moving the blank to the salt moulded part removal device. The handling devices are robots, for example.

It is beneficial for the injection moulding machine to have an injection mould that enclose the support body during operation. Preferably, the salt moulded part production machine has a cooling device to cool the support body. In this way support bodies can be used that are made of a material whose melting point is not above the temperature of the liquid salt or the liquid salt mixture, which represents a preferred embodiment of the invention.

In the following, the invention will be explained in more detail with the aid of the accompanying drawings. They show:

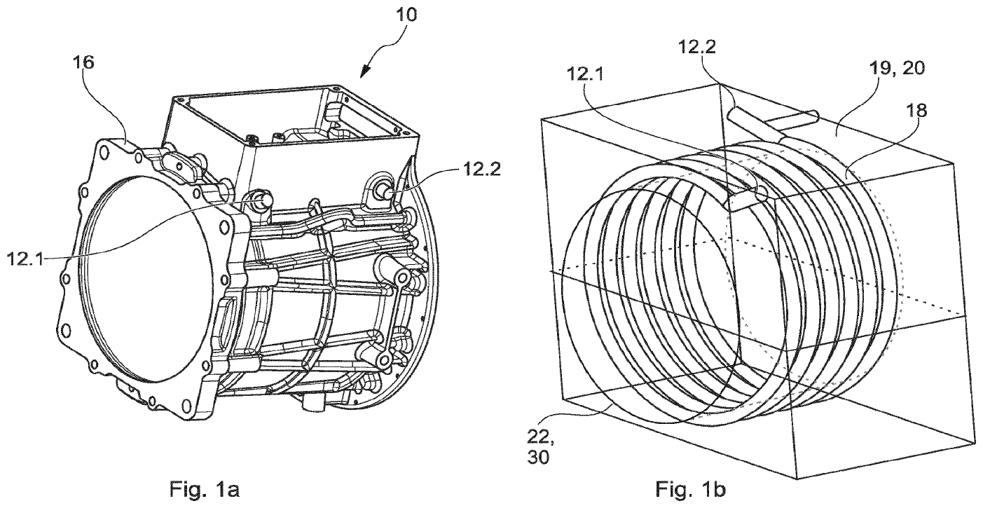

FIG. 1a a perspective view of a cast part according to the invention, which has been produced by means of a method according to the invention,

FIG. 1b a perspective view of a salt moulded part that is used within the scope of the method according to the invention,

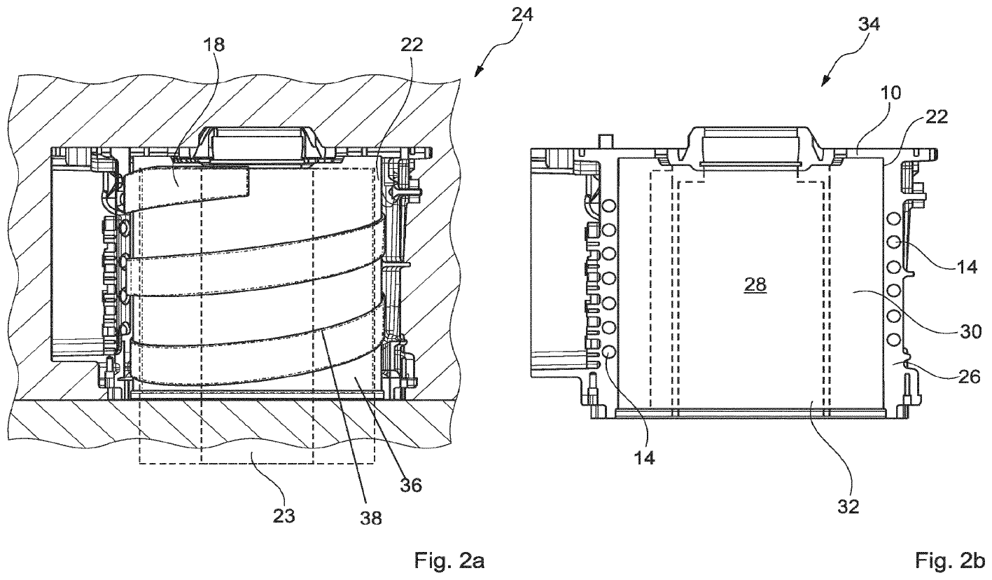

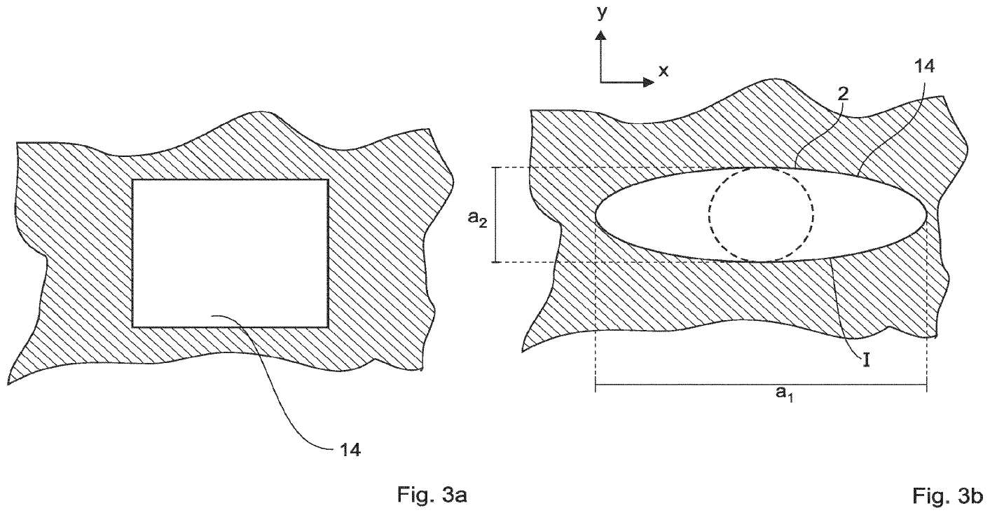

FIG. 2a a view from above of the salt moulded part according to FIG. 1b, which is arranged in an injection mould and has a rectangular cross-section,

FIG. 2b a cross-section through a finished cast part according to an alternative embodiment in which the cooling channel has a round cross-section,

FIG. 3a a cross-section through a channel of a cast part according to the invention for an electric motor according to the invention and

FIG. 3b a cross-section through a channel of a cast part according to the invention for an electric motor according to the invention according to a second embodiment.

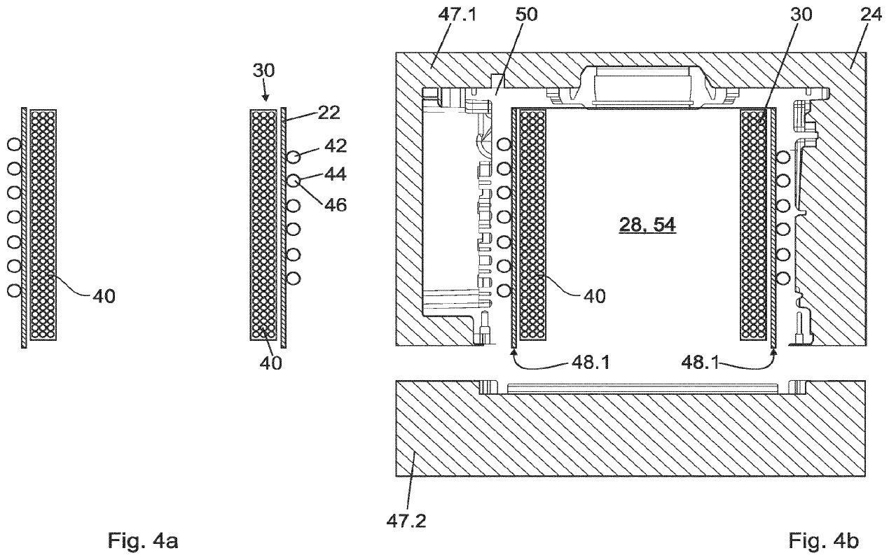

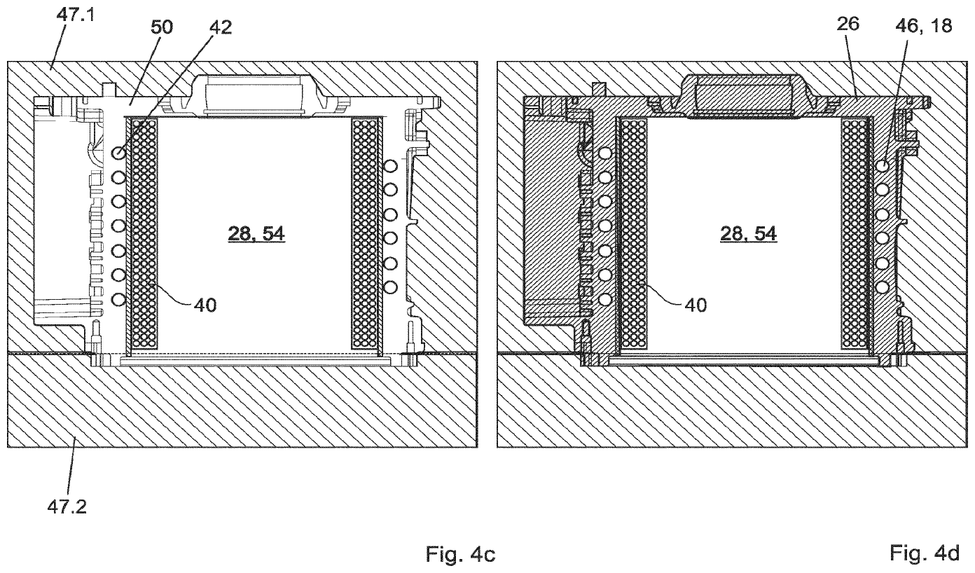

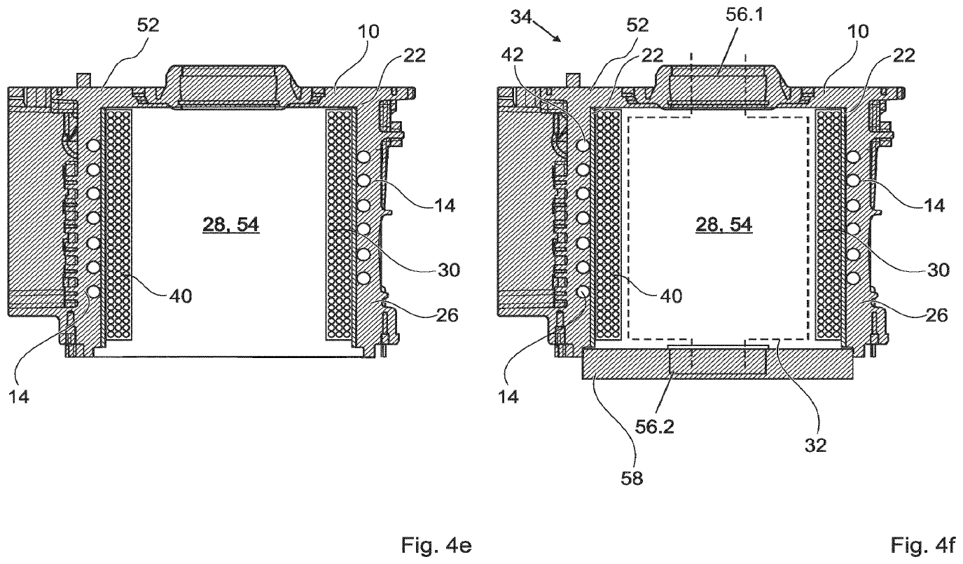

FIGS. 4a to 4f schematically depict the sequence of a method according to the invention.

FIG. 1a shows a perspective view of a finished cast part 10, which in the present case is a housing of an electric motor. The cast part 10 has a first connection 12.1 and a second connection 12.2, which are connected inside the cast part 10 to a channel 14 shown in FIG. 2b, said channel being a cooling channel in the present case. As shown in the present case, the cast part 10 may comprise a mounting flange 16 for mounting it on other components.

FIG. 1b shows a salt moulded part 18 in a schematically depicted salt moulded part mould 19, here in the form of a salt moulded part casting mould 20. Alternatively, the salt moulded part mould 19 can also be a core shooting mould into which salt or a salt mixture, which preferably contains soluble glass, is injected.

Here, the salt moulded part 18 is produced by low-pressure gravity die casting and is composed of the following salt mixture: 62±5% Na₂CO₃ and 38∓5% KCl, in particular 62±3% Na₂CO₃ and 38±3% KCl. Alternatively, a salt mixture made of, for example, 52.95±5% Na₂CO₃ and 47.05±5% KCl, in particular 52.95±3% Na₂CO₃ und 47.05±3% KCl can deliver good results. All percentages are percentages by weight.

The salt moulded part 18 is produced by means of low-pressure gravity die casting by first producing a salt moulded part casting mould 20, for example a two-part salt moulded part casting mould 20, in particular a gravity die casting mould. The gravity die casting mould is preferably produced from hot-working steel.

The salt moulded part casting mould 20 is constructed around a support body 22. Following the production of the gravity die casting mould 20, liquid salt is poured into the gravity die casting mould 20.

The salt moulded part 18 is sufficiently supported on the support body 22 so that it can be moved. The salt moulded part 18 is then transferred into a casting mould 24 (see FIG. 2a), in particular an injection mould. The injection mould is preferably designed to have two parts. Once the injection mould has been closed, liquid metal, in the present case an aluminium alloy, particularly a non-eutectic to eutectic aluminium/silicon casting alloy, is introduced into the casting mould and solidified.

FIG. 2a schematically depicts the casting mould 24 with the inserted salt moulded part 18 on the support body 22. A folding core 23 is schematically depicted, which prevents the support core from compressing. In the embodiment according to FIG. 2a, the support body has a round cross-section, which represents a preferred embodiment independent of the other properties of the embodiment.

FIG. 2b shows a cross-section through a finished cast part 10, which was produced by means of a salt moulded part that had a round cross-section. It should be noted that the support body 22 is securely connected to a casting 26 due to the casting with metal. Since the support body 22 is preferably not a cast, but rather has been extruded, for example, it is preferably free from cavities, so that the channel 14, which acts in the present case as a cooling channel, is securely sealed relative to an interior chamber 28.

A stator 30, which bears electromagnets, was mounted in the interior chamber in a subsequent assembly step. The stator 30 is connected to the support body 22 such that it is torque-proof.

It is particularly advantageous—quite generally and independently of the features otherwise described with respect to the present embodiment—if the stator 30 has already been arranged on the support body 22 prior to the insertion of the support body 22 and the salt moulded part 18 into the casting mould 24. For example, the stator 30 may be arranged relative to the support body 22 such that the stator 30 can be moved relative to the support body 22 prior to casting, and such that the stator 30 is connected to the support body 22 in a torque-free manner by casting around the support body 22.

The stator 30 is in thermal contact with the support body 22. In the present case, the support body 22 is made of a wrought aluminium alloy. The casting 26 is made of an aluminium alloy-casting alloy. However, the support body 22 and the casting can also be made of the same aluminium alloy.

A rotor 32 is subsequently mounted, thereby obtaining an electric motor 34.

FIG. 3a shows a cross-section through the channel 14. It should be noted that the channel 14 can have a non-round cross-section. In the case illustrated in FIG. 4, the cross-section is rectangular.

FIG. 3b shows another possible cross-section of the channel 14, which is designed to be flat. In this case, a first recess (a₁) in a first direction, which can also be referred to as the x-direction, is more than 1.5-times as big as a second recess a₂ parallel to the x-direction. This direction can be referred to as the y-direction. The first recess a₁ is significantly larger than an inner circle diameter D_{I} of an inner circle I of the cross-section. The inner circle I touches an edge R of the channel 14, but does not intersect it.

FIG. 2a also schematically shows, by way of a dot-dashed line, an inner surface 36 of the inner compensation cylinder. The inner compensation cylinder is the imaginary cylinder that describes the inner surface of the support body 22 with minimum square sum of the deviations. A projection of the salt moulded part 18 onto the inner surface 36 is likewise illustrated with a dot-dashed line. The surface of the projection of the salt moulded part onto the inner surface of the support body represents at least one tenth, especially at least one eighth, preferably at least one sixth, especially preferably at least one quarter of the inner surface. This creates a good cooling effect.

FIGS. 4a to 4f depict the sequence of a method according to the invention. As shown in FIG. 4a, a stator part in the form of the stator 30, which comprises at least one electromagnet 40, is first positioned in the support body 22, which can be tubular. It should be recognised that the stator 30 can be inserted into the support body 22 with clearance.

Prior to or after this, a casting core 42, which may refer to a filled pipe 44 with a salt core 46, is arranged on the support body 22. As described above in FIG. 1, this is done, for example, by casting onto the support body 22 or by core shooting.

FIG. 4b illustrates the situation in which the support body 22, the casting core 42 and the stator part 30 are arranged in an interior chamber 28 of a casting mould 24, which can be an injection mould. The casting mould 24 has a first mould half 47.1 and a second mould half 47.2.

If the second mould half 47.2 moves towards the first mould half 47.1, as indicated by the arrow P, a first support body end face 48.1, which could also be called the end face, comes into contact with the second mould half. As a result, the interior chamber 28 is securely separated from a filling area 50. This situation is shown in FIG. 4c.

FIG. 4d shows the subsequent step, in which liquid metal is injected into the filling area 50 at an injection pressure p_{S}. The injection pressure p_{S} is selected to be so great, for example, that the support body 22 deforms radially inwards. This results in a torque-proof connection between the support body 22 and the stator part 30. It is also possible to select the injection pressure in such a way that the support body 22 does not deform. In this case, it is beneficial to select a densification pressure p_{N} to be so great that the resulting casting 26, which contracts upon cooling, deforms the stator part such that it forms a torque-proof connection with the stator part 30.

After cooling, the casting 26 along with the parts connected to the casting 26, in particular the stator part 30 and the support body 22, form an electric motor housing 52. FIG. 4e shows the electric motor housing 52 after de-moulding.

After de-moulding, a rotor 28 is mounted in a stator interior chamber 54, as shown in FIG. 4f. The rotor 28 is arranged in a first pivot bearing 56.1. A second pivot bearing 56.2 is arranged on a cover piece 52, which is connected to the electric motor housing 52.

The salt core 46/the salt moulded part 18 is flushed with a solvent, usually water. With that, the electric motor 34 is complete.

### REFERENCE LIST

10 cast part, housing
12 connection
14 channel
16 mounting flange
18 salt moulded part
19 salt moulded part mould
20 salt moulded part casting mould, gravity die casting mould
22 support body
23 folding core
24 casting mould
26 casting
28 interior chamber
30 stator part, stator
32 rotor
34 electric motor
36 inner surface of the inner compensation cylinder
38 projection of the channel 14
40 electromagnet
42 casting core
44 pipe
46 salt core
47 mould part, mould half
48 support body end face
50 filling area
52 electric motor housing
54 stator interior chamber
56 pivot bearing
58 cover piece
a expansion
R edge
L_{R} edge length
D_{I} inner circle diameter
I inner circle
P_{N} densification pressure
p_{S} injection pressure
P arrow

The invention claimed is:

1. A method for producing an electric motor housing, comprising:
(a) positioning at least one stator part in a support body interior chamber of a support body,
(b) arranging a casting core on the support body,
(c) casting liquid metal around the support body and the casting core to produce a torque-proof connection between the at least one stator part and a casting as a result of solidification of the liquid metal.

2. The method according to claim 1, wherein
the support body is arranged in a casting mould such a that the support body interior chamber of the support body is sealed against the casting mould, and
casting the liquid metal is done such that no liquid metal enters the support body interior chamber.

3. The method according to claim 1 wherein
casting the liquid metal is done at an injection pressure that causes the support body to deform radially inwards, and/or
the injection pressure of the liquid metal during casting and/or a densification pressure of the liquid metal during solidification is selected such that the torque-proof connection forms between the at least one stator part and the casting core.

4. The method according to one of the preceding claims, further comprising:
after arranging the support body in the casting mould, closing the casting mould by moving at least two mould parts towards each other,
wherein when the at least two mould parts are moved towards each other, the support body is sealed against the casting mould.

5. The method according to claim 1 wherein the at least one stator part is fixed in the casting mould.

6. The method according to claim 1 wherein the at least one stator part has such a radial strength that the support body interior chamber has interior dimensions after de-moulding that are equivalent to dimensions present after positioning in the support body.

7. The method according to claim 1 wherein the at least one stator part is not permanently connected to the support body prior to casting the liquid metal around the support body.

8. The method according to according to claim 1 wherein
the casting core comprises a salt moulded part or a pipe with a salt core, and further comprising
dissolving the salt moulded part or the salt core so as to produce a channel.

9. The method according to claim 1 wherein
the at least one stator part has a stator part projection and/or a stator part recess on a stator part outer side, and
wherein the support body has a support body recess on a support body inner side, said support body_recess forming a form-fit connection with the stator part projection and/or the support body projection which forms a form-fit connection with the stator part recess, and/or
the at least one stator part has a stator part projection and/or a stator part recess on at least one stator part end face, and the support body has a support body recess on a support body inner side, said support body recess forming a form-fit connection with the stator part projection and/or a support body projection which forms a form-fit connection with the stator part recess.

10. The method according to claim 1 wherein the casting core is supported during casting by the support body.

11. The method according to claim 1 wherein
(a) the support body has a cylindrical lateral surface at least in sections, and/or
(b) the liquid metal is cast around or onto the support body, and/or
(c) the torque proof connection encloses the support body in a spiral shape at least in sections.

12. The method according to claim 1, further comprising:
(i) introducing salt or a salt mixture in liquid form into a mould for a salt moulded part that encloses the support body (22), the salt or salt mixture coming into contact with the support body so that the salt moulded part rests against the support body,
(ii) collectively de-moulding the salt moulded part 18) and the support body, and
(iii) arranging the salt moulded part and the support body (22) in casting mould, wherein the salt moulded part is not separated from the support body until arrangement in the casting mould.

13. The method according to claim 12 wherein
the introduction of the salt or the salt mixture into the mould for the salt moulded part is a core shooting of the salt or the salt mixture into a core-shooting mould, and/or
the salt or the salt mixture contains soluble glass.

14. The method according to claim 12 wherein
(a) the mould for the salt moulded part encloses or contains the support body,
(b) the mould for the salt moulded part contains a negative structure of the salt moulded part, and
(c) the negative structure abuts the support body so that the salt or the salt mixture comes into contact with the support body.

15. The method according to claim 1, further comprising:
(a) inserting a rotor into a housing, and/or
(b) connecting a channel to a first connection and a second connection so that a fluid is conductable through the first connection into the channel and out of the channel by the second connection.

16. A cast part production system for producing an electric motor housing, comprising:
(a) a salt moulded part production machine for producing a salt moulded part that comprises
(i) a mould for a salt moulded part,
(ii) an insertion device designed to automatically enclose a support body and introduce a salt or a salt mixture in liquid form into the mould for the salt moulded part so that the salt or salt mixture comes into contact with the support body, and
(iii) a de-moulding device for de-moulding the salt moulded part, resulting in a pre-blank,
(b) an injection moulding machine for injection moulding metal around the salt moulded part resulting in a blank, wherein the injection moulding machine comprises an injection mould configured to enclose the support body, and
(c) a salt moulded part removal device for dissolving the salt moulded part resulting in the electric motor housing.

17. The cast part production system according to claim 16, further comprising:
a stator insertion device that is configured to automatically insert a stator part into the support body,
(b) a first handling device for moving the pre-blank from the salt moulded part production machine to the injection moulding machine, and/or
(c) a handling device for moving the blank from the injection moulding machine to the salt moulded part removal device.

18. An electric motor, comprising:
(a) a one-piece cast electric motor housing in which a cooling channel extends, wherein the cooling channel, at least in sections, does not extend in a straight line,
(b) a housing or housing part is produced entirely from identical casting material.

19. The electric motor according to claim 18 wherein
the channel has a non-round cross-section.
